(19) United States
(12) Patent Application Publication
(10) Pub. No.: US 2025/0282314 A1
(43) Pub. Date: Sep. 11, 2025

(54) PIPELINE JOINT FOR AUTOMOBILES

(71) Applicant: NINGBO HENGSHUAI CO.,LTD., Ningbo (CN)

(72) Inventors: Zhelei Huang, Ningbo (CN); Hengshuai Xu, Ningbo (CN); Peihai Liu, Ningbo (CN)

(21) Appl. No.: 19/215,226

(22) Filed: May 21, 2025

(30) Foreign Application Priority Data
Apr. 23, 2025 (CN) 202520784840.5

(51) Int. Cl. B60R 16/08; F16L 37/088

(52) U.S. Cl. CPC B60R 16/08; F16L 37/0885

(57) ABSTRACT

A pipeline joint for automobiles includes a main body and a fixing clip, where the fixing clip is formed of an elastic material and is assembled in a placement groove of the main body in a limiting manner in an axial direction of the main body, and protrusions of the fixing clip extend into holes of the placement groove and are convexly assembled on inner walls so as to use the protrusions for butt locking, and the connection process does not require operation of the fixing clip, and the disassembly operation is convenient.

### TECHNICAL FIELD

The present invention relates to the technical field of pipeline connection devices, and more particularly, to a pipeline joint for automobiles.

### BACKGROUND

Pipe joints are connecting tools between pipes or pipelines. Common pipe joints include straight tees, elbows, right angles and other configurations. Common butting between pipe joints is threaded connections, but threaded connection structures are troublesome to operate in various application environments and need to be improved.

For example, in an automobile windshield cleaning system, a pipeline butting device is provided to butt a cleaning liquid pipeline so as to facilitate production, mounting and subsequent maintenance and replacement. However, the existing pipelines are complex to operate during mounting and disassembly.

### SUMMARY

In order to solve at least one of the above technical defects, the present invention provides the following technical solution.

The present application document discloses a pipeline joint for automobiles, which includes a main body having a channel for transporting a liquid therein, a placement groove is provided at a peripheral wall of the main body along a circumferential direction, and a notch ring-shaped fixing clip formed of an elastic material is nested and connected to the placement groove, the fixing clip is limited by groove walls on both sides of the placement groove in an axial direction of the main body to prevent the fixing clip from axial displacement, protrusions are inwardly convexly formed on inner walls of two legs of the fixing clip, and the protrusions extend into holes formed through a bottom wall of the placement groove and is convexly disposed on an inner wall of the channel.

When the pipeline joint is butted with other joints to be butted, end portions of the other joints are inserted from a channel opening until they are butted in place, and then the fixing clip formed of the elastic material is reset, so that the protrusions are snapped into snap-in slots provided at peripheral walls of the end portions of the other joints to form a limit to prevent the butted joint from disengaging, achieving the purpose of convenient joint butting. When it is necessary to disengage the butting, the fixing clip is first operated to unlock so as to separate the protrusions from the snap-in slots, and then the butted joint can be disengaged.

Here, the fixing clip is preferably in the shape of a notch ring, and the existence of the notch facilitates the fixing clip to be nested with the main body. Of course, when other joints are butted, the fixing clip can also be directly removed, and then nested and connected with the main body through the notch after the other joints are butted.

The elastic material forming the fixing clip, such as plastic, polymer materials, spring steel, etc., can be chosen freely according to the needs.

Compared with the prior art, the present invention has the following beneficial effects:

1. The present invention improves the structure of the pipeline joint for automobiles, and fixing other joints to be butted by the fixing clip can improve the efficiency of pipeline butting, and result in good tightness after butting.

2. Just inserting the joint can realize butting, and to remove connection, the fixing clip is first operated for unlocking and then the butted joint is disengaged in the axial direction, which is easy to operate.

### BRIEF DESCRIPTION OF THE DRAWINGS

In order to illustrate the technical solutions of the embodiments of the present invention more clearly, the accompanying drawings required for the description of the embodiments will be briefly introduced below. Apparently, the accompanying drawings in the following description are merely some rather than all embodiments of the present invention, and a person of ordinary skill in the art may still derive other drawings from these accompanying drawings without creative efforts.

FIG. 1 is a schematic structural diagram of a pipeline joint according to Embodiment 1;

FIG. 2 is a schematic structural diagram of the pipeline joint according to Embodiment 1;

FIG. 3 is a schematic cross-sectional structural diagram of the pipeline joint according to Embodiment 1;

FIG. 4 is a schematic structural diagram of a fixing clip according to Embodiment 1; and

FIG. 5 is a schematic structural diagram of a pipeline joint according to another embodiment.

### DESCRIPTION OF THE EMBODIMENTS

The present invention will be further described below with reference to the accompanying drawings and specific embodiments.

### Embodiment 1

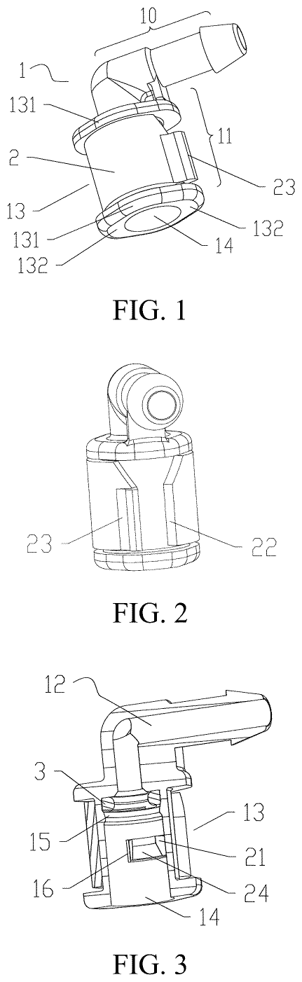

As shown in FIGS. 1 and 2, a pipe joint for automobiles according to the present embodiment includes a main body 1. In the present embodiment, the main body 1 has a common right angle shape as shown in FIG. 1, the main body 1 includes a first joint portion 11 and a second joint portion 10 connected with each other, the first joint portion 11 is for insertion of other joints, and the second joint portion 10 is for insertion of other pipe joints to be butted. Of course, in other embodiments, the second joint portion 10 can also be disposed in a straight-through shape as shown in FIG. 5.

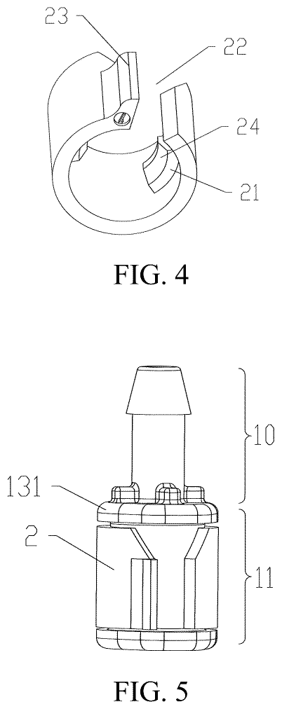

As shown in FIG. 3, a channel 12 for transporting a liquid is formed in the main body 1, and the liquid can pass through the channel 12. It is of course possible to butt with other joints through a channel opening 14.

In the present embodiment, a groove, i.e., a placement groove 13, is formed circumferentially at a peripheral wall of the first joint portion 11 in the main body 1, and a notch ring-shaped fixing clip 2 formed of an elastic material is connected to the placement groove 13 in a nesting manner. The notch ring shape refers to a configuration in which a notch is formed on the ring body, and the notch size can be selected according to the needs.

In the present embodiment, the fixing clip 2 can be formed of plastic and nested at the placement groove 13 through the notch, and an inner diameter of the ring of the fixing clip 2 can be less than or equal to an outer diameter of the main body at the adjacent placement groove 13, and then the fixing clip 2 is limited by groove walls 131 on both sides of the placement groove 13 in an axial direction of the main body 1. Preferably, one side convex member 132 is respectively provided in an opposite direction of each of the groove walls 131, and the side convex member 132 is provided corresponding to a push handle 23 to prevent the push handle 23 from being pushed unexpectedly after the fixing clip 2 is mounted.

Protrusions 21 are inwardly convexly formed at two legs of the fixing clip 2. As shown in FIGS. 3 and 4, two protrusions 21 are preferably disposed opposite to each other, and most preferably disposed in a direction perpendicular to the notch respectively (other positions can also be selected according to the needs), holes 16 into which the protrusions 21 can be inserted are formed at corresponding positions on a bottom wall of the placement groove 13, and the protrusions 21 extend into the holes 16 formed through the bottom wall of the placement groove 13 and are convexly disposed on an inner wall of the channel 12 of the main body 1. The fixing clip 2 is preferably mounted in advance on the placement groove 13 of the main body 1 to constitute the pipe joint of the present embodiment.

When in use, end portions of other joints to be butted are inserted into the channel opening 14 of the first joint portion 11 of the pipeline joint and the fixing clip 2 is pushed to expand appropriately until the joint is butted in place, and the fixing clip formed of the elastic material is restored to cause the protrusions to be snapped into snap-in slots formed on a peripheral wall of the joint to be butted, thereby restricting the joint to be butted from disengaging in the axial direction and realizing butting.

As shown in FIGS. 3 and 4, the protrusions 21 are in the shape of an inclined surface 24 at an end surface of the channel opening 14 facing an end portion of the main body 1, and when the joint to be butted is inserted, the protrusion 21 can be automatically expanded to bypass by a guide action of abutting the inclined surface 24 until the protrusions 21 are correspondingly snapped into the snap-in slots disposed at the peripheral wall of the end portion of the butted joint, and reset by elastic force to form a limit, resulting in convenient connection.

In order to facilitate the separation of the butted joints, in the present embodiment, the push handle 23 that can provide pushing force is also formed at a peripheral wall of the fixing clip 2, the push handle 23 is in the shape of a plate (or other rod-shaped configurations can be used) as shown in FIG. 4, and the push handle 23 is preferably formed at an end face of the notch 22. When in use, a finger force is applied to the push handle to open the fixing clip 2 to release the limit between the protrusions 21 and the snap-in slots.

In order to improve the tightness of the butted joint, in the present embodiment, a sealing ring 3 is also provided in the channel in the first joint portion 11. In order to improve the stability of the sealing ring, as shown in FIG. 3, in the present embodiment, an inner diameter of the channel in the first joint portion 11 is larger than an inner diameter of the channel in the second joint portion 10, and a convex ridge, that is, a limiting ring 15, is formed in the first joint portion 11 adjacent to the channel in the second joint portion 10. The limiting ring 15 and a channel wall of the adjacent second joint portion 10 surround a receiving groove, and the sealing ring 3 is in the receiving groove. After the butting is completed, a front end of the butted joint can abut against the sealing ring 3 to improve the tightness.

The above are merely preferred embodiments of the present invention and are not intended to limit the scope of protection thereof, and all the technical solutions under the inventive concept fall within the scope of protection of the present invention. It should be noted that those of ordinary skill in the art can make a plurality of improvements and modifications without departing from the principles of the disclosure, and such modifications and modifications shall be construed to fall into the scope of the disclosure.

What is claimed is:

1. A pipeline joint for automobiles, comprising:
a main body, a channel for transporting a liquid being provided in the main body, a placement groove being provided at a peripheral wall of the main body along a circumferential direction, and holes being provided through a bottom wall of the placement groove; and
a fixing clip formed of an elastic material and nested and connected to the placement groove, an axial position of the fixing clip being limited on the main body by groove walls provided on axial sides of the mounting groove; and
wherein protrusions are inwardly convexly formed on inner walls of two legs of the fixing clip, and the protrusions extend into the holes and are convexly formed on an inner wall of the channel in the placement groove.

2. The pipeline joint for automobiles according to claim 1, wherein the main body comprises a first joint portion and a second joint portion connected with each other, and the placement groove is disposed on the peripheral wall close to the first joint portion, and
side convex members opposite to a push handle on the mounted fixing clip are provided on the groove walls to prevent the side convex members from being pushed unexpectedly.

3. The pipeline joint for automobiles according to claim 2, wherein a sealing ring is provided in the first joint portion.

4. The pipeline joint for automobiles according to claim 3, wherein an inner diameter of the channel in the first joint portion is larger than an inner diameter of the channel in the second joint portion, the channel in the first joint portion is provided with a limiting ring adjacent to the second joint portion, the limiting ring is spaced apart from a side wall of the second joint portion to form a receiving groove therebetween, and the sealing ring is located in the receiving groove.

5. The pipeline joint for automobiles according to claim 4, wherein the channel forms a channel opening at one end of the first joint portion away from the second joint portion, and the protrusions are formed with an inclined surface on a side facing the channel opening.

6. The pipeline joint for automobiles according to claim 4, wherein the push handle is disposed on the fixing clip.

7. The pipeline joint for automobiles according to claim 6, wherein the fixing clip is formed of an annular member having a notch, and the push handle is disposed close to the notch.

8. The pipeline joint for automobiles according to claim 4, wherein two projections are disposed opposite to each other.
